(19) United States
(12) Patent Application Publication
(10) Pub. No.: US 2013/0094965 A1
(43) Pub. Date: Apr. 18, 2013

(54) WATERCRAFT PROPULSION DEVICE

(71) Applicant: Morihiro OOISHI, Shizuoka (JP)

(72) Inventor: Morihiro OOISHI, Shizuoka (JP)

(73) Assignee: YAMAHA HATSUDOKI KABUSHIKI KAISHA, Iwata-shi (JP)

(21) Appl. No.: 13/461,822

(22) Filed: May 2, 2012

(30) Foreign Application Priority Data
Oct. 13, 2011 (JP) 2011-226167

(51) Int. Cl. F02D 29/02; G01L 1/12

(52) U.S. Cl. 416/43; 416/61

(57) ABSTRACT

A watercraft propulsion device includes an engine, a drive shaft, a propeller shaft, a shift mechanism, an operation force transmitting mechanism, and a magnetostrictive sensor. The drive shaft transmits power from the engine. The propeller shaft is rotationally driven by power transmitted from the drive shaft. The shift mechanism changes a rotation direction of power transmitted from the drive shaft to the propeller shaft. The operating force transmitting mechanism connects to the shift mechanism and transmits a shift operation force to the shift mechanism to cause the shift mechanism operate. The magnetostrictive sensor detects a load acting on the operation force transmitting mechanism.

### BACKGROUND OF THE INVENTION

1. Field of the Invention

The present invention relates to a watercraft propulsion device.

2. Description of the Related Art

A watercraft propulsion device is configured to propel a watercraft by driving a propeller with power from an engine. A watercraft propulsion device is equipped with a shift mechanism for changing a rotation direction of the propeller. The shift mechanism is configured to change a rotation direction of power transmitted from a drive shaft to a propeller shaft. In this way, the watercraft can be switched between forward propulsion and reverse propulsion. For example, Laid-open Japanese Patent Application Publication 2002-332903 discloses a watercraft propulsion device having a shift mechanism including a shift cable connected to a shift operation shaft through a slider. A shift operation is conveyed to the slider through the shift cable and causes the slider to move. The movement of the slider causes the shift operation shaft to operate. The operation of the shift operation shaft changes the rotation direction of the propeller shaft.

In the watercraft propulsion device of Laid-open Japanese Patent Application Publication 2002-332903, a limit switch is arranged near the slider. When a load equal to or larger than a prescribed value is exerted on the slider by a shift operation, the slider rotates and presses a limit switch. When the limit switch is pressed, the limit switch sends an on-signal to an ECU.

When the shift mechanism installed in the watercraft propulsion device according to Laid-open Japanese Patent Application Publication 2002-332903 is used, it is possible to detect an excessive load acting on the slider. For example, even when a shift operation is being performed, there are situations in which it takes time for a dog clutch and a bevel gear contained in the shift mechanism to mesh together. In such a situation, a large load will act on the shift mechanism until the meshing is accomplished. Thus, as explained previously, a load acting on the shift mechanism causes the slider to rotate and press the limit switch such that the limit switch sends an on-signal to the ECU. Consequently, the ECU can detect that an excess load is acting on the shift mechanism based on the on-signal of the limit switch. When the ECU determines that an excess load is acting on the shift mechanism, it can switch the shift mechanism quickly by adopting such a countermeasure as executing a control to suppress an output of the engine.

However, in a watercraft propulsion device like that explained previously, the load required to rotate the slider changes over a period of years due to changes in the shift cable, the slider, or the shift operation shaft. Thus, even if the load is the same, there is a possibility that the slider may rotate or not rotate due to such changes. In such a case, it is difficult to accurately detect if an excessive load is acting on the shift mechanism based on rotation of the slider.

### SUMMARY OF THE INVENTION

Preferred embodiments of the present invention provide a watercraft propulsion device that accurately detects if an excessive load is acting on a shift mechanism.

A watercraft propulsion device according to a preferred embodiment of the present invention includes an engine, a drive shaft, a propeller shaft, a shift mechanism, an operation force transmitting mechanism, and a magnetostrictive sensor. The drive shaft transmits power from the engine. The propeller shaft is rotationally driven by power transmitted from the drive shaft. The shift mechanism changes a rotation direction of power transmitted from the drive shaft to the propeller shaft. The operation force transmitting mechanism connects to the shift mechanism and transmits a shift operation force to the shift mechanism to cause the shift mechanism operate. The magnetostrictive sensor detects a load acting on the operation force transmitting mechanism.

With a watercraft propulsion device according to a preferred embodiment of the present invention, a load acting on the operation force transmitting mechanism is accurately detected by the magnetostrictive sensor. Consequently, the effects of changes occurring in the operation force transmitting mechanism over a period of years are suppressed and an excessive load acting on the shift mechanism is detected accurately.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a watercraft propulsion device according to a preferred embodiment of the present invention.

FIG. 2 is a block diagram showing an engine control system and an operating device of the watercraft propulsion device.

FIG. 3 is a partial sectional view taken along a section line III-III of FIG. 1.

FIG. 4 is a perspective view of an operation force transmitting mechanism.

FIG. 5 is a partial sectional view of a watercraft propulsion device in accordance with another preferred embodiment of the present invention.

FIGS. 6A and 6B is an enlarged view of a shift actuator and a link mechanism shown in FIG. 5.

FIG. 7 shows a mounting position of a magnetostrictive sensor in accordance with another preferred embodiment of the present invention.

### DETAILED DESCRIPTION OF THE PREFERRED EMBODIMENTS

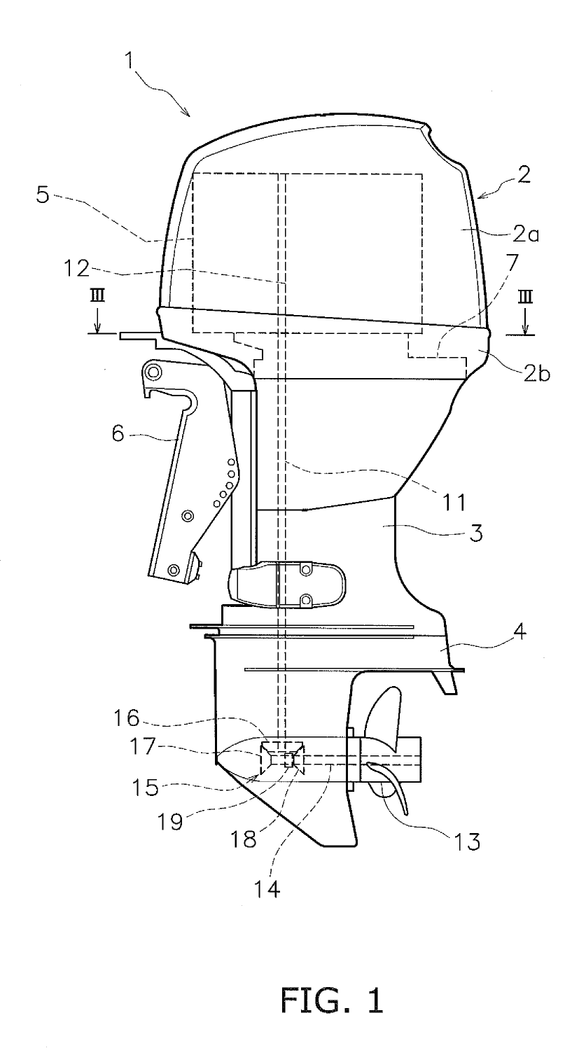

A watercraft propulsion device according to preferred embodiments of the present invention will now be explained with reference to the drawings. FIG. 1 is a side view of a watercraft propulsion device 1 according to a preferred embodiment of the present invention. The watercraft propulsion device 1 preferably is an outboard boat motor. The watercraft propulsion device 1 includes an engine cover 2, an upper casing 3, a lower casing 4, an engine 5, and a bracket 6. The engine cover 2 houses the engine 5. The engine cover 2 includes an upper engine cover 2a and a lower engine cover 2b. The upper engine cover 2a is arranged above the lower engine cover 2b. The upper casing 3 is arranged below the lower engine cover 2b. The lower casing 4 is arranged below the upper casing 3. The watercraft propulsion device 1 is attached to a hull (not shown) through the bracket 6.

The engine 5 is arranged inside the engine cover 2. The engine 5 is arranged on an exhaust guide 7. The exhaust guide 7 is arranged inside the lower engine cover 2b. The engine 5 is a multiple cylinder engine and the cylinders are arranged vertically adjacent to one another. The engine 5 includes a crankshaft 12. The crankshaft 12 extends along a vertical direction. A drive shaft 11 is arranged inside the upper casing 3 and the lower casing 4. The drive shaft 11 is arranged to extend along a vertical direction inside the upper casing 3 and the lower casing 4. The drive shaft 11 is connected to a crankshaft 12 of the engine 5 and transmits power from the engine 5. A propeller 13 is arranged on a lower portion of the lower casing 4. The propeller 13 is arranged below the engine 5. The propeller 13 is connected to a propeller shaft 14. The propeller shaft 14 is arranged to extend along a front-to-rear direction. The propeller shaft 14 connects to a lower portion of the drive shaft 11 through a shift mechanism 15. The propeller shaft 14 is rotationally driven by power transmitted from the drive shaft 11.

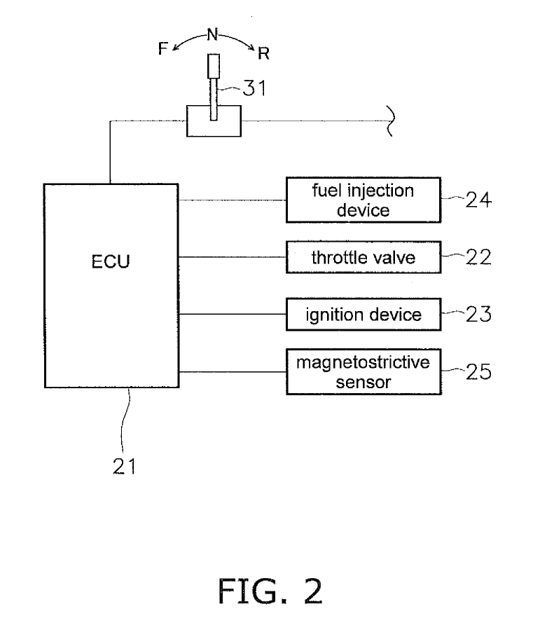

The shift mechanism 15 is configured to change a rotation direction of power transmitted from the drive shaft 11 to the propeller shaft 14. The shift mechanism 15 includes a pinion gear 16, a forward propulsion gear 17, a reverse propulsion gear 18, and a dog clutch 19. The pinion gear 16 is connected to the drive shaft 11. The pinion gear 16 meshes with the forward propulsion gear 17 and the reverse propulsion gear 18. The forward propulsion gear 17 and the reverse propulsion gear 18 are arranged such that they can undergo relative rotation with respect to the propeller shaft 14. The dog clutch 19 is attached to the propeller shaft 14 such that it cannot rotate relative to the propeller shaft 14. The dog clutch 19 is arranged such that it can move along an axial direction of the propeller shaft 14 to a forward propulsion position, a reverse propulsion position, and a neutral position. The dog clutch 19 moves between the forward propulsion position, the reverse propulsion position, and the neutral position in response to operation of an operating member 31 (see FIG. 2) that is explained later. In the forward propulsion position, the dog clutch 19 fastens the forward propulsion gear 17 and the propeller shaft 14 together such that they cannot undergo relative rotation. In this state, rotation of the drive shaft 11 is transmitted to the propeller shaft 14 through the forward propulsion gear 17. As a result, the propeller 13 rotates in a direction of propelling the hull forward. In the reverse propulsion position, the dog clutch 19 fastens the reverse propulsion gear 18 and the propeller shaft 14 together such that they cannot undergo relative rotation. In this state, rotation of the drive shaft 11 is transmitted to the propeller shaft 14 through the reverse propulsion gear 18. As a result, the propeller 13 rotates in a direction of propelling the hull rearward. When the dog clutch 19 is in the neutral position located between the forward propulsion position and the reverse propulsion position, the forward propulsion gear 17 and the reverse propulsion gear 18 can rotate relative to the propeller shaft 14. Thus, rotation from the drive shaft 11 is not transmitted to the propeller shaft 14 and the propeller shaft 14 can rotate idly.

FIG. 2 is a block diagram showing a control system of the engine 5 and an operating member 31 of the watercraft propulsion device 1. The engine 5 is controlled by an ECU 21 (engine control unit). The ECU 21 is an example of a controller according to a preferred embodiment of the present invention. The ECU 21 stores a control program that controls the engine 5. The ECU 21 controls operations of a fuel injection device 22, a throttle valve 23, and a spark ignition device 24 based on information related to the engine 5 detected by various sensors (not shown). The fuel injection device 22 is configured to inject fuel into a combustion chamber of the engine 5. An amount of air-fuel mixture delivered to the combustion chamber is adjusted by varying an opening degree of the throttle valve 23. The ignition device 24 ignites fuel inside the combustion chamber. Although not depicted in FIG. 2, a fuel injection device 22, a throttle valve 23, and an ignition device 24 are provided on each cylinder of the engine 5.

The operating member 31 is attached to the hull. The operating member 31 is, for example, an operating lever. The operating member 31 is configured to send an operation signal to control an output of the engine 5 to the ECU 21 in response to an operation of the operating member 31. The ECU 21 controls the engine 5 based on the operation signal from the operating member 31. When an operator operates the operating member 31, an operation signal indicating a detection value corresponding to a position of the operating member 31 is issued from the operating member 31. This operation signal can be used to control a throttle opening degree and, thus, a speed of the hull. The operator can also select whether to propel the hull forward or in reverse by operating the operating member 31. More specifically, the operating member 31 can be set to any one of a forward propulsion position (F), a reverse propulsion position (R), and a neutral position (N). An operation of the operating member 31 is transmitted to the shift mechanism 15 via an operation force transmitting mechanism 41 (explained later).

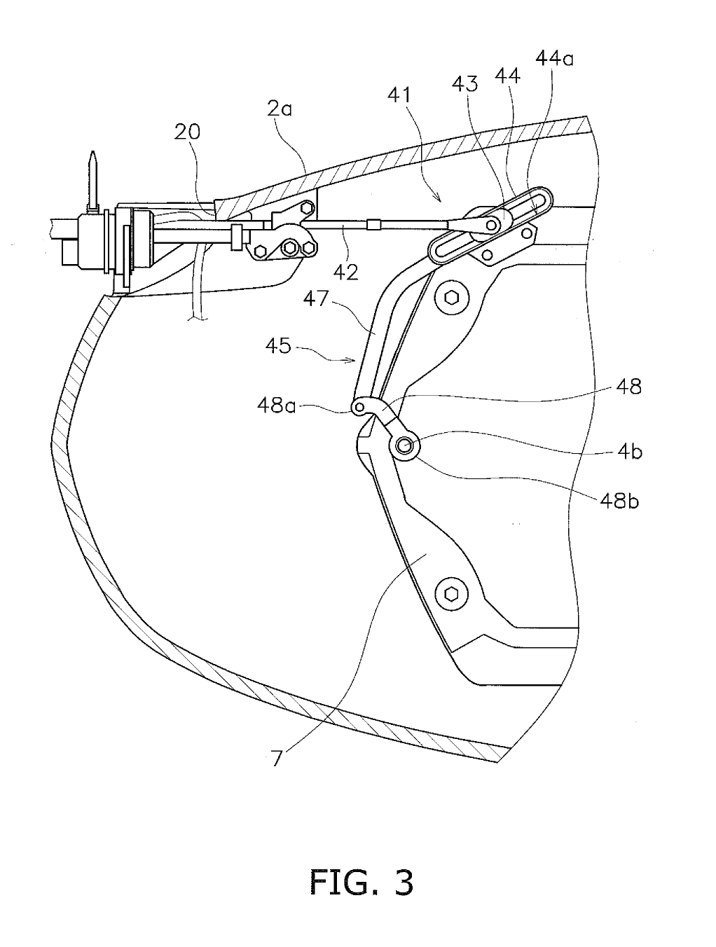

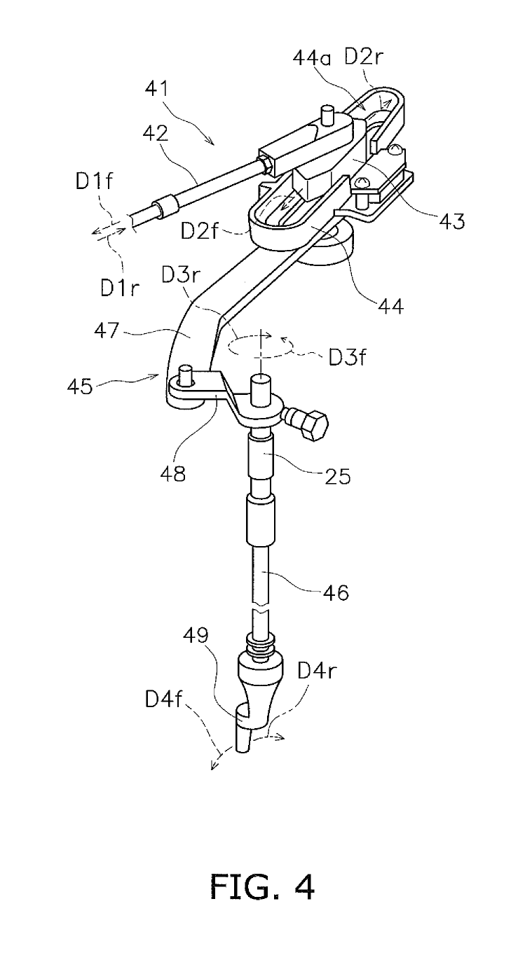

FIG. 3 is a partial sectional view taken along a section line III-III of FIG. 1. FIG. 4 is a perspective view of the operation force transmitting mechanism 41. The operation force transmitting mechanism 41 is connected to the shift mechanism 15 and transmits a shift operation force to operate the shift mechanism 15. More specifically, the operation force transmitting mechanism 41 transmits a shift operation force imparted to the operating member 31 to the shift mechanism 15. The operation force transmitting mechanism 41 includes a wire 42, a slider 43, a guide member 44, a link mechanism 45, and a shift rod 46. The wire 42 is connected to the operating member 31. The wire 42 is passed through a through hole 20 formed in the lower engine cover 2b and is inserted into the engine cover 2. The slider 43 is connected to the wire 42. A tip end of the wire 42 is pivotally connected to the slider 43. The guide member 44 guides the movement of the slider 43. The guide member 44 includes a trough-shaped portion 44a. The slider 43 is arranged inside the trough-shaped portion 44a. The slider 43 moves along the trough-shaped portion 44a. The guide member 44 is fixed to the watercraft propulsion device 1. For example, it is acceptable for the guide member 44 to be fixed to the exhaust guide 7. The link mechanism 45 is connected to the slider 43. The link mechanism 45 is connected to the shift rod 46. More specifically, the link mechanism 45 includes a first link member 47 and a second link member 48. The first link member 47 is pivotally connected to the slider 43. The first link member 47 has a bent shape. The second link member 48 includes a first end portion 48a that is pivotally connected to the first link member 47. The second link member 48 includes a second end portion 48b that is fixed to an upper portion of the shift load 46. When the first link member 47 exerts a force against the first end portion 48a, the second link member 48 rotates about a center axis of the shift rod 46. Thus, the link mechanism 45 converts a linear movement of the slider 43 into a rotational movement of the shift rod 46. As shown in FIG. 4, a crank portion 49 is arranged on a lower portion of the shift rod 46. The crank portion 49 is arranged eccentrically with respect to the center axis of the shift rod 46. The crank portion 49 is configured to move the dog clutch 19 (see FIG. 1) of the shift mechanism 15 by contacting the dog clutch 19 when the shift rod 46 rotates about its center axis.

More specifically, when an operator moves the operating member 31 to the forward propulsion position (F) as shown in FIG. 2, the wire 42 is pulled in a D1f direction as shown in FIG. 4. As a result, the slider 43 moves in a D2f direction. The movement of the slider 43 is transmitted to the shift rod 46 by the link mechanism 45 and the shift rod 46 rotates in a D3f direction. The crank portion 49 then moves in a D4f direction and causes the dog clutch 19 shown in FIG. 1 to move to the forward propulsion position. If the operator moves the operating member 31 to the reverse propulsion position (R), then the wire 42 is pushed in a Dir direction as shown in FIG. 4. As a result, the slider 43 moves in a D2r direction. The movement of the slider 43 is transmitted to the shift rod 46 by the link mechanism 45 and the shift rod 46 rotates in a D3r direction. The crank portion 49 then moves in a D4r direction and causes the dog clutch 19 shown in FIG. 1 to move to the reverse propulsion position.

As shown in FIG. 2 and FIG. 4, the watercraft propulsion device 1 includes a magnetostrictive sensor 25. The magnetostrictive sensor 25 is configured to detect a load acting on the operation force transmitting mechanism 41. More specifically, the magnetostrictive sensor 25 is attached to the shift rod 46 and arranged coaxially with respect to the shift rod 46. The magnetostrictive sensor 25 is positioned below the second link member 48. The magnetostrictive sensor 25 is configured to detect a load acting on the shift rod 46 in a torsional direction. That is, the magnetostrictive sensor 25 is configured to detect a torque acting on the shift rod 46. The magnetostrictive sensor 25 includes a magnetic body and a detection coil (not shown) and functions by using the detection coil to detect an output voltage corresponding to a change in a magnetic field occurring due to a deformation of the magnetic body. Thus, the magnetostrictive sensor 25 detects an output voltage corresponding to a torque. The magnetostrictive sensor 25 can be a known magnetostrictive sensor, e.g., the sensor disclosed in Laid-open Japanese Patent Application Publication 2004-184190.

When the magnetostrictive sensor 25 detects a load equal to or larger than a prescribed value, the ECU 21 executes a control to suppress a rotational speed of the engine 5. The control to suppress the rotational speed of the engine 5 uses, for example, such a method as an ignition cut, a fuel injection cut, a reduction of a throttle opening degree, a change of ignition timing, or a change to a leaner air-fuel mixture. It is acceptable for the control to suppress the rotational speed of the engine 5 to use any one of these methods or to use a combination of two or more of these methods. An ignition cut control is configured to control the ignition device 24 such that spark ignition of an air-fuel mixture is stopped. A fuel injection cut control is configured to control the fuel injection device 22 such that an injection of fuel is stopped. A throttle opening reduction control is configured to control the throttle valve 23 such that a throttle opening is reduced. An ignition timing change control is configured to execute spark ignition of fuel at a time later than a normal ignition timing. An air-fuel mixture leaning control is configured to control the throttle valve 23 and/or the fuel injection device 22 such that the ratio of fuel in the air-fuel mixture is reduced. It is acceptable for the ignition cut control and/or the fuel cut control to target all of the cylinders of the engine 5, a plural portion of the cylinders, or only one of the cylinders. It is also acceptable for the ignition cut control and/or the fuel injection cut control to target a designated cylinder or a cylinder synchronized with a timing at which the control to suppress the rotational speed of the engine 5 is executed. It is also acceptable for the ignition cut control and/or the fuel injection cut control to be executed only once, continuously, or intermittently, for example.

With a watercraft propulsion device 1 according to a preferred embodiment of the present invention, a load acting on the operation force transmitting mechanism 41 is accurately detected by the magnetostrictive sensor 25. Consequently, the effects of changes occurring in the operation force transmitting mechanism 41 over a period of years are suppressed and an excessive load acting on the shift mechanism 15 is detected accurately.

Since a control to suppress the rotational speed of the engine 5 is executed when the load detected by the magnetostrictive sensor 25 is equal to or larger than a prescribed value, a load imposed on the shift mechanism 15 during a shift operation is reduced.

Additionally, since the load is detected accurately by the magnetostrictive sensor 25, the load reducing effect is accomplished in a stable and reliable manner. Consequently, an operating performance of the watercraft propulsion device 1 is stabilized.

Although a preferred embodiment of the present invention has been described above, the present invention is not limited to the preferred embodiment described above. Various changes can be made without departing from the scope of the present invention.

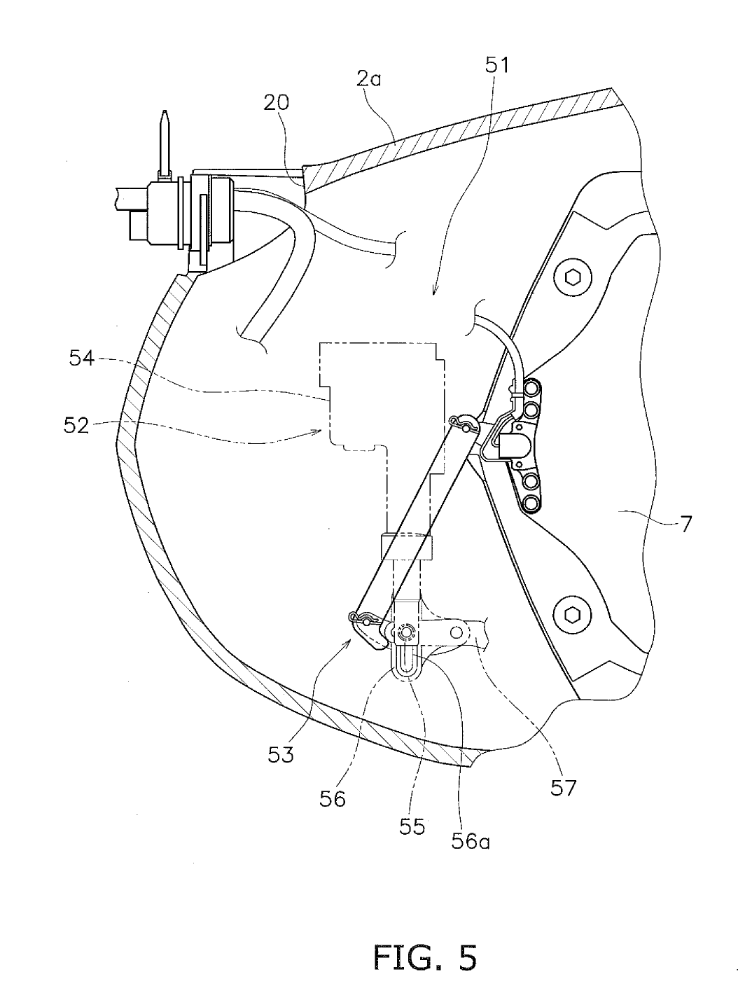

Although in the preferred embodiment described above the operation of the operating member preferably is transmitted mechanically through a mechanism including a wire 42, a slider 43, and a link mechanism 45, it is acceptable for the operation to be transmitted using an electrical mechanism. For example, as shown in FIG. 5, it is acceptable to use an operation force transmitting mechanism 51 that includes a shift actuator 52 and a link mechanism 53. The shift actuator 52 is driven based on an operation of the operating member 31 (see FIG. 2). More specifically, the shift actuator 52 is an electric powered cylinder that includes a main body portion 54 and a moveable portion 55. The main body portion 54 is fixed to the watercraft propulsion device 1. The main body portion 54 is fixed to the engine 5. It is also acceptable for the main body portion 54 to be fixed to the exhaust guide 7. The operating member 31 sends the ECU 21 an operation signal corresponding to an operating position of the operating member 31. The ECU 21 controls the shift actuator 52 based on the operation signal from the operating member 31. The shift actuator 52 moves the moveable portion 55 relative to the main body portion 54 in response to a command signal from the ECU 21. The moveable portion 55 is a rod-shaped member configured to extend and retract with respect to the main body portion 54. The moveable portion 55 is arranged such that it can move relative to a guide rail 56. The guide rail 56 includes a trough-shaped portion 56a. The moveable portion 55 is arranged inside the trough-shaped portion 56a. The moveable portion 55 moves along the trough-shaped portion 56a. The guide rail 56 is fixed to the watercraft propulsion device 1. The guide rail 56 is fixed, for example, to the engine 5 through a support portion 57. It is also acceptable if the guide rail 56 is fixed to the exhaust guide 7 through a support portion 57. The moveable portion 55 moves along the guide rail 56.

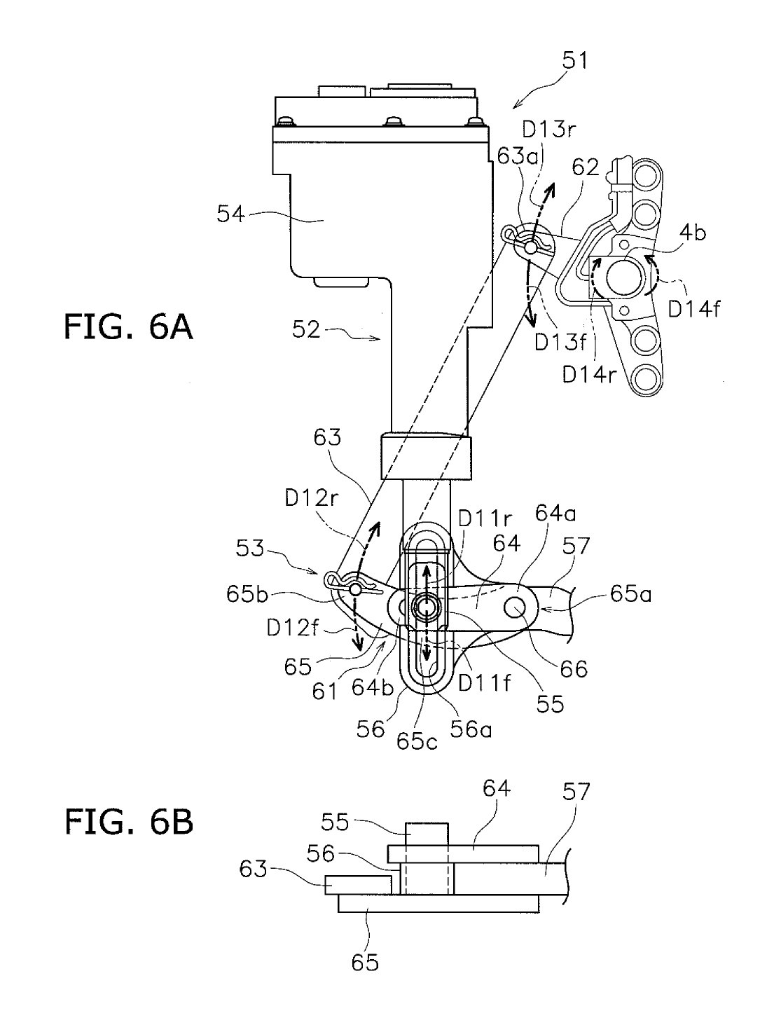

FIG. 6A is an enlarged view of the shift actuator 52 and the link mechanism 53 shown in FIG. 5. FIG. 6B is a side view of the shift actuator 52 and the link mechanism 53. The link mechanism 53 includes a first link member 61 and a second link member 62. The first link member 61 is connected to the moveable portion 55. The first link member 61 includes an upper link member 64, a lower link member 65, and a connecting member 63. A base end portion 64a of the upper link member 64 and a base end portion 65a of the lower link member 65 are each rotatably supported on a common rotation shaft 66. The upper link member 64 is arranged above the guide rail 56. A tip end portion 64b of the upper link member 64 is pivotally connected to the moveable portion 55. The lower link member 65 is arranged below the guide rail 56. A tip end portion 65b of the lower link member 65 is preferably provided as a one-piece integral unit with an end portion of the connecting member 63. Another end portion of the connecting member 63 is pivotally connected to the second link member 62. An intermediate portion 65c disposed between the base end portion 65a and the tip end portion 65b of the lower link member 65 is pivotally connected to the moveable portion 55. The first link member 61 is pivotally connected to the second link member 62. The second link member 62 is fixed to the shift rod 46.

When an operator moves the operating member 31 to the forward propulsion position (F), the ECU 21 controls the shift actuator 52 such that the moveable portion 55 is moved in a D11f direction. The lower link member 65 then rotates about the rotation shaft 66 such that the tip end portion 65b of the lower link member 65 moves in a D12f direction. The movement of the lower link member 65 is transmitted to the second link member 62 through the connecting member 63 and the tip end portion 63a of the second link member 62 moves in a D13f direction. As a result, the shift rod 46 rotates in a D14f direction. Similarly to the previously explained embodiment, the dog clutch 19 shown in FIG. 1 is moved to the forward propulsion position when the link portion 49 moves in the D4f direction as shown in FIG. 4. When an operator moves the operating member 31 to the reverse propulsion position (R), the ECU 21 controls the shift actuator 52 such that the moveable portion 55 is moved in a D11r direction shown in FIGS. 6A and 6B. The lower link member 65 then rotates about the rotation shaft 66 such that the tip end portion 65b of the lower link member 65 moves in a D12r direction. The movement of the lower link member 65 is transmitted to the second link member 62 through the connecting member 63 and the tip end portion 63a of the second link member 62 moves in a D13r direction. As a result, the shift rod 46 rotates in a D14r direction. Similarly to the previously explained preferred embodiment, the dog clutch 19 shown in FIG. 1 is moved to the reverse propulsion position when the link portion 49 moves in the D4r direction as shown in FIG. 4.

As mentioned previously, even if operations of the operating member 31 are transmitted using an electrical mechanism, the same effects can be obtained as with the watercraft propulsion device 1 according to the previously explained preferred embodiment.

It is acceptable for the ECU 21 to be configured to execute a calibration control to calibrate the magnetostrictive sensor 25. In such a case, for example, the ECU 21 detects a load via the magnetostrictive sensor 25 when the shift mechanism 15 has just been assembled and is in a neutral state and stores the detected value as a calibration reference value. Afterwards, the ECU 21 calibrates the magnetostrictive sensor 25 based on the stored reference value and a load detected by the magnetostrictive sensor 25 while the shift mechanism 15 is in a neutral state. In this way, the detection precision of the magnetostrictive sensor 25 can be improved.

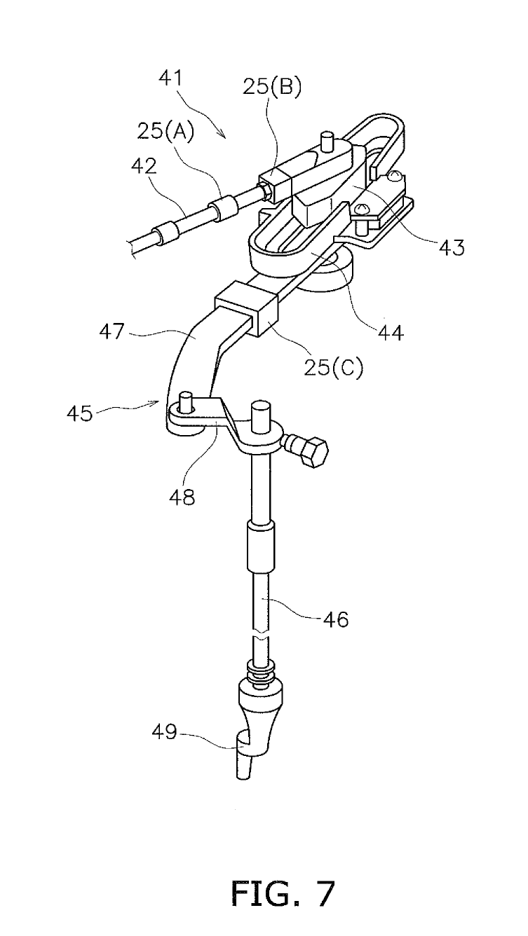

Although in the previously explained preferred embodiment, the magnetostrictive sensor 25 preferably is attached to the shift rod 46, the mounting position of the magnetostrictive sensor 25 is not limited to the shift rod 46. Also, the magnetostrictive sensor 25 is not limited to detecting a load oriented in a torsional direction and it is acceptable for the magnetostrictive sensor 25 to detect a load oriented in a direction of elongation and contraction. An example of a known magnetostrictive sensor configured to detect a load oriented in a direction of elongation and contraction that can be used is disclosed in Laid-open Japanese Patent Application Publication 2010-38913. In such a case, it is preferable for a magnetostrictive sensor 25 to be attached to the wire 42 (position A), the slider 43 (position B), or the first link member 47 (position C) as shown in FIG. 7 or a combination of these positions. It is also acceptable to attach a magnetostrictive sensor 25 to any one of the shift rod 46 and the positions A, B, and C shown in FIG. 7 or to attach magnetostrictive sensors 25 in a combination of these positions.

Although in the previously explained preferred embodiment an outboard boat motor is presented as an example of the watercraft propulsion device, various preferred embodiments of the present invention can be applied to other types of watercraft propulsion devices. For example, it is acceptable to apply various preferred embodiments of the present invention to an inboard/outboard motor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft propulsion device comprising:
an engine;
a drive shaft that transmits power from the engine;
a propeller shaft rotationally driven by power transmitted from the drive shaft;
a shift mechanism that changes a rotation direction of the propeller shaft;
an operation force transmitting mechanism that is connected to the shift mechanism and transmits a shift operation force to the shift mechanism to cause the shift mechanism to operate; and
a magnetostrictive sensor that detects a load acting on the operation force transmitting mechanism.

2. The watercraft propulsion device according to claim 1, wherein the operation force transmitting mechanism includes a shift rod, and the magnetostrictive sensor detects a load acting on the shift rod.

3. The watercraft propulsion device according to claim 1, further comprising a controller programmed to execute a control to suppress a rotational speed of the engine when a load detected by the magnetostrictive sensor is equal to or larger than a prescribed value.

4. The watercraft propulsion device according to claim 1, further comprising a controller programmed to use the magnetostrictive sensor to detect the load when the shift mechanism is in a neutral state and to calibrate the magnetostrictive sensor based on the load detected when the shift mechanism is in the neutral state.

5. The watercraft propulsion device according to claim 1, further comprising:
an operating member to be operated by an operator; wherein
the operation force transmitting mechanism includes a wire connected to the operating member, a slider connected to the wire, a link mechanism connected to the slider, and a shift rod connected to the link mechanism; and
the magnetostrictive sensor detects a load acting on the shift rod.

6. The watercraft propulsion device according to claim 5, wherein the operation force transmitting mechanism further includes a guide member that guides a movement of the slider and is fixed to the watercraft propulsion device.

7. The watercraft propulsion device according to claim 1, further comprising:
an operating member to be operated by an operator; wherein
the operation force transmitting mechanism includes an actuator to be driven based on an operation of the operating member, a link mechanism connected to the actuator, and a shift rod connected to the link mechanism; and
the magnetostrictive sensor detects a load acting on the shift rod.
